(19) United States
(12) Patent Application Publication
(10) Pub. No.: US 2009/0307374 A1
(43) Pub. Date: Dec. 10, 2009

(54) Method And System For Providing A Subscription To A Tuple Based On A Schema Associated With The Tuple

(76) Inventor: Robert P. Morris, Raleigh, NC (US)

Correspondence Address: SCENERA RESEARCH, LLC, 111 CORNING RD., SUITE 220, CARY, NC, 27518, US

(21) Appl. No.: 12/133,630

(22) Filed: Jun. 5, 2008

(51) Int. Cl. G06F 15/16

(52) U.S. Cl. 709/246

(57) ABSTRACT

Methods, systems and computer program products are described for providing a subscription to a tuple based on a schema associated with the tuple. In one aspect, a system includes a message router component configured for receiving a message identifying a principal and including subscription information identifying a schema that specifies a set of constraints that defines a structure and vocabulary of a conforming tuple. The system also includes a conformance detector component configured for determining a conforming tuple, where at least a portion of the conforming tuple conforms to the identified schema, and a subscription handler component configured for establishing for the identified principal a subscription to the conforming tuple based on the subscription information.

### COPYRIGHT NOTICE

A portion of the disclosure of this patent document contains material which is subject to copyright protection. The copyright owner has no objection to the facsimile reproduction by anyone of the Patent and Trademark Office patent file or records, but otherwise reserves all copyright rights whatsoever.

### BACKGROUND

One mode of exchanging information over the Internet uses a publish/subscribe (pub/sub), asynchronous, communication protocol. The commands of an asynchronous protocol, such as the pub/sub communication protocol, are structured such that there need not be a one-to-one correspondence between messages exchanged between communication entities. In some cases a publisher of information via the protocol need not wait for, nor expect, a response from a receiver of a message. Moreover, a receiver need not send a request for each message received. That is, a receiver may receive multiple messages associated with a sent message and/or may receive an unsolicited message. Thus, unlike a request/response, synchronous protocol where the response is sent directly (synchronously) and only in response to the entity's request, the information can instead be sent in to a receiver in the absence of a corresponding request from the receiver (i.e., asynchronous to any request for information).

According to pub/sub communication protocols, a pub/sub service can receive published information from a publisher and asynchronously deliver such information to receivers. Typically, the pub/sub service stores and organizes such information in a data entity known as a tuple, which in its broadest sense, is a data object containing one or more tuple elements into which information is organized and stored. The information stored in a tuple is associated with a principal, which can represent a user, a group, an application, an entity, or a device, that owns the tuple. Each tuple can be identified by a tuple identifier (ID), e.g., a uniform resource identifier (URI) or uniform resource locator (URL), and the principal can publish information to its associated tuple using the tuple ID.

An entity interested in receiving information published by a principal can subscribe to the principal's associated tuple by providing the tuple ID. When the principal publishes updated information identifying the tuple to be created or updated, the pub/sub service updates the tuple information and transmits the updated information to all interested entities, i.e., subscribers, via notification messages. The published information can be read simultaneously by any number of subscribers. So long as the subscriber remains subscribed to the information, the subscriber can continue to receive notification messages corresponding to the principal's postings.

Notably, as is used herein, the term “publish/subscribe” refers to the class of services and associated protocols where a subscriber receives only the most recently published information in a notification message resulting from a subscription. That is, the pub/sub service transmits to the subscriber only the most current state of the published information in response to new and/or updated tuple information. In addition, the pub/sub services as described herein are not topic or content based subscription services. In topic based subscription services, whether published information is sent to a subscriber is based on its topic or content. While such topic and content based subscription services are also sometimes referred to as pub/sub services, they do not come within the scope of the services described herein.

Existing pub/sub services allow subscribers to subscribe to tuples in order to receive updated tuple information asynchronously. As stated above, the subscriber can subscribe to a particular tuple by providing the tuple's ID so that the pub/sub service can identify and provide a subscription for the subscriber to the particular tuple. Nonetheless, if the subscriber cannot provide the tuple's ID, the subscription cannot be established. Alternatively, topic or content based pub/sub services allow the subscriber to subscribe to a tuple based on its topic or content by identifying a topic or content so that the pub/sub service can identify tuples relating to the topic or content.

In light of these limitations, it would be desirable to provide a subscription to a tuple without regard to the tuple's ID and/or its topic or content. Accordingly, there exists a need for methods, systems, and computer program products for providing a subscription to a tuple based on the tuple's schema, i.e., its vocabulary and/or structure.

### SUMMARY

Methods, systems and computer program products are described for providing a subscription to a tuple based on a schema associated with the tuple. In one aspect, a system includes a message router component configured for receiving a message identifying a principal and including subscription information identifying a schema that specifies a set of constraints that defines a structure and vocabulary of a conforming tuple. The system also includes a conformance detector component configured for determining a conforming tuple, where at least a portion of the conforming tuple conforms to the identified schema, and a subscription handler component configured for establishing for the identified principal a subscription to the conforming tuple based on the subscription information.

In another aspect of the subject matter disclosed herein, another system for providing a subscription to a tuple based on a schema associated with the tuple includes a publish/subscribe agent configured for generating a message identifying a principal and including subscription information identifying a schema that specifies a set of constraints that defines a structure and vocabulary of a conforming tuple, and a protocol interface component configured for sending the message to a service node for establishing for the identified principal a subscription to a conforming tuple managed by the service node where at least a portion of the conforming tuple conforms to the identified schema.

In another aspect of the subject matter disclosed herein, a method and a computer readable medium containing a computer program, executable by a machine, for providing a subscription to a tuple based on a schema associated with the tuple includes executable instructions for generating a message identifying a principal and including subscription information identifying a schema that specifies a set of constraints that defines a structure and vocabulary of a conforming tuple, and sending the message to a service node for establishing for the identified principal a subscription to a conforming tuple managed by the service node, wherein at least a portion of the conforming tuple conforms to the identified schema.

In another aspect of the subject matter disclosed herein, another method and a computer readable medium containing a computer program, executable by a machine, for providing a subscription to a tuple based on a schema associated with the tuple includes executable instructions for receiving a message identifying a principal and including subscription information identifying a schema that specifies a set of constraints that defines a structure and vocabulary of a conforming tuple, determining a conforming tuple, wherein at least a portion of the conforming tuple conforms to the identified schema, and establishing for the identified principal a subscription to the conforming tuple based on the subscription information.

### BRIEF DESCRIPTION OF THE DRAWINGS

Objects and advantages of the present invention will become apparent to those skilled in the art upon reading this description in conjunction with the accompanying drawings, in which like reference numerals have been used to designate like elements, and in which:

FIG. 1 is a flow diagram illustrating a method for providing a subscription to a tuple based on a schema associated with the tuple according to an exemplary embodiment;

FIG. 2 is a block diagram illustrating a system for providing a subscription to a tuple based on a schema associated with the tuple according to an exemplary embodiment;

FIG. 3 is a block diagram illustrating another system for providing a subscription to a tuple based on a schema associated with the tuple according to another exemplary embodiment;

FIG. 4 illustrates an exemplary tuple structure according to one embodiment;

FIG. 5 a flow diagram illustrating another method for providing a subscription to a tuple based on a schema associated with the tuple according to another exemplary embodiment;

FIG. 6 is a block diagram illustrating a system for implementing the method of FIG. 5 according to an exemplary embodiment; and

FIG. 7 is a block diagram illustrating another system for implementing the method of FIG. 5 according to another exemplary embodiment.

### DETAILED DESCRIPTION

Various aspects will now be described in connection with exemplary embodiments, including certain aspects described in terms of sequences of actions that can be performed by elements of a computing device or system. For example, it will be recognized that in each of the embodiments, at least some of the various actions can be performed by specialized circuits or circuitry (e.g., discrete and/or integrated logic gates interconnected to perform a specialized function), by program instructions being executed by one or more processors, or by a combination of both. Thus, the various aspects can be embodied in many different forms, and all such forms are contemplated to be within the scope of what is described.

Methods, systems, and computer program products for providing a subscription to a tuple based on a schema associated with the tuple are described. According to an exemplary embodiment, a pub/sub communication architecture and its underlying messaging protocol allow published information to be sent to a subscriber as it is received, in many instances, substantially in real-time in relation to the publication of the information. Information is published within the pub/sub communication architecture using a publish command. The published information can then be communicated to a subscriber using a notify command. The notify command can either include the published information or can provide a reference to the published information.

By way of example, aspects of an exemplary embodiment described here can employ a presence protocol as the pub/sub communications protocol. It should be understood, however, the relevant techniques described here can be performed using any pub/sub communications protocol as defined herein. Additionally, the exemplary embodiment described herein is not limited to the use of a pub/sub protocol for all communications described. Other known protocols can also be used.

The architecture, models, and protocols associated with presence services in general are described in “Request for Comments” (or RFC) documents RFC 2778 to Day et al., titled “A Model for Presence and Instant Messaging” (February 2000), RFC 2779 to Day et al., titled “Instant Messaging/Presence Protocol” (February 2000), and RFC 3921 to Saint-Andre et. al, titled “Extensible Messaging and Presence Protocol (XMPP): Instant Messaging and Presence,” each of which are published and owned by the Internet Society and incorporated here in their entirety by reference. A pub/sub protocol, as defined herein, includes any protocol meeting the requirements for a presence protocol as specified in RFC 2779 with the exception that there are no requirements for the content of a pub/sub tuple. That is, a pub/sub tuple is not required to support any particular content, such as status and contact means, as required by RFC 2779 for a presence protocol.

Generally speaking, one or more service nodes are used to provide pub/sub services. The function of a service node, however, can be incorporated, either in whole or in part, into other entities. For example, the presence service model can be used. The presence service model described in RFC 2778 describes two distinct agents of a presence service client. The first of these agents, called a “presentity” (combining the terms “presence” and “entity”), provides presence information to be stored and distributed throughout the presence service on behalf of a presence client. The second type of presence agent is referred to as a “watcher”. Watchers receive presence information from a presence service on behalf of a presence client.

Users of the presence service are referred to, in the presence model described in RFC 2778, as principals. Typically, a principal is a person or group that exists outside of the presence model. A principal can also be a software component, a hardware component, or other resource capable of interacting with the presence service. A principal can interact with the presence system through a “presence user agent” (PUA) or a “watcher user agent” (WUA). As in the case of the presentity and watcher clients with which these service clients interact, the presence and watcher user agents can be combined functionally as a single user agent having both the characteristics of the presence and watcher user agents. User agents can be implemented such that their functionality exists within a presence service, external to a presence service, or a combination of both. Similar statements can be made about presentities and watchers.

As mentioned above, a pub/sub service typically stores and organizes published information into tuples. A tuple can represent any element used to store the published information associated with a resource, e.g., a publisher/principal. The published information may include general contact information for the network resource, such as a name, a telephone number, an email address, a postal address, and IP addresses or URLs associated with the resource, and the like, as well as other data or content. As used here, the tuple can also be a representation that maps field names to certain values to indicate that an entity or object (e.g., the principal) includes certain components, information, and/or perhaps has certain properties.

According to one embodiment, at least a portion of the structure and vocabulary of a tuple is constrained by a schema. As used herein, a schema specifies a set of constraints that define a structure and a vocabulary of a conforming tuple. For example, the schema can specify syntax and structural constraints, formatting restrictions, relationships between tuple elements, and allowable element content. In one embodiment, one portion of a tuple can satisfy the specifications of one schema, and another portion of the tuple can satisfy the specifications of another schema. As a whole, this tuple can be considered a conforming tuple with respect to either or both schemas.

According to aspects of an exemplary embodiment described herein, a pub/sub service is configured to provide a subscription to a tuple based on a schema associated with the tuple. In one embodiment, the pub/sub service is configured to receive a message that identifies a schema for at least a portion of a tuple. For example, the schema can be associated with active auction tuples or voice contact tuples. The message also identifies a principal for which a subscription is to be created. When such a message is received, the pub/sub service is configured to identify a conforming tuple, or a portion thereof, that conforms to the schema and to establish a subscription to the tuple for the principal. In this manner, a subscription to at least a portion of a conforming tuple can be provided without prior knowledge of the tuple's ID, and/or the tuple's owner. Once the subscription is established, the principal can receive notification messages associated with updates to the conforming tuple.

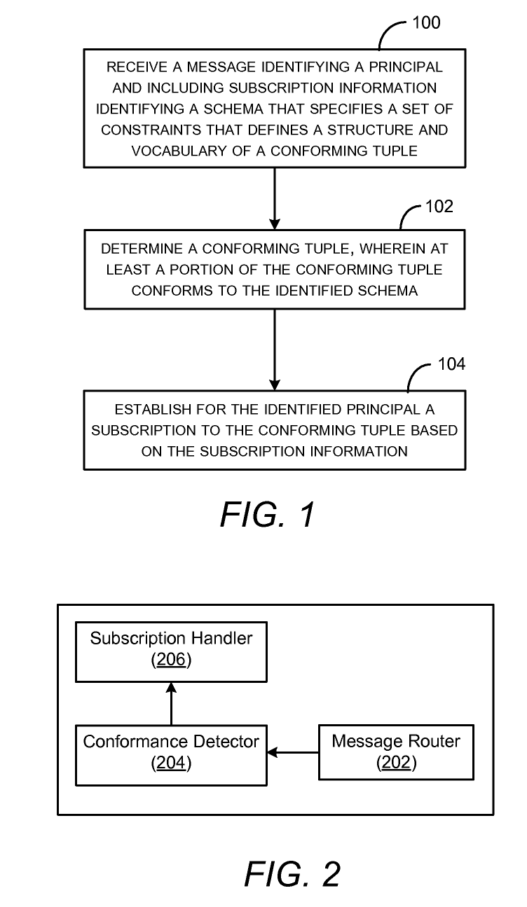

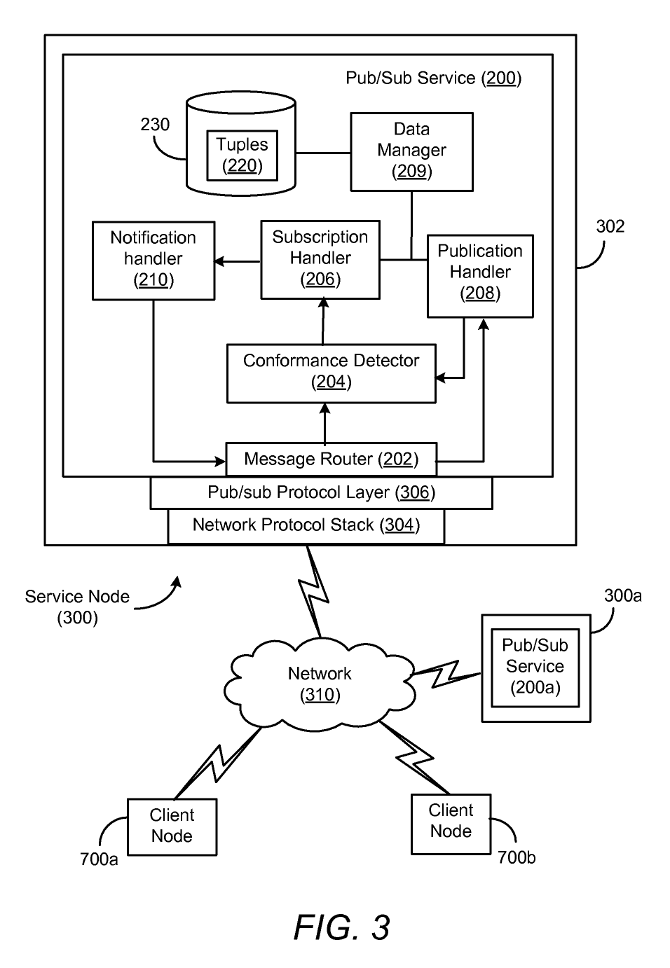

FIG. 1 is a flow diagram illustrating a method for providing a subscription to a tuple based on a schema associated with the tuple according to an exemplary embodiment. FIGS. 2 and 3 are block diagrams illustrating systems for providing a subscription to a tuple based on a schema associated with the tuple according to embodiments of the subject matter described herein. In particular, FIG. 2 illustrates a an arrangement of components configured for providing a subscription to a tuple based on a schema associated with the tuple, while FIG. 3 illustrates a service node hosting an the arrangement of components for providing a subscription to a tuple based on a schema associated with the tuple. The method illustrated in FIG. 1 can be carried out by, for example, by at least some of the components in each of the exemplary arrangements of components illustrated in FIGS. 2 and 3.

Illustrated in FIG. 2 illustrates an arrangement of components that is configured to operate within an execution environment of a device or a group of devices. The arrangement can operate within a wide range of execution environments and devices. For example, the components in FIG. 2 can operate in an execution environment including hardware, such as a processor, for processing instructions included in the components in FIG. 2, and a processor memory for storing at least a portion of the components allowing the processor to access instructions and data included in the arrangement.

Illustrated in FIG. 3 is a service node device 300 that hosts a pub/sub service 200 including the components illustrated in FIG. 2 adapted for operating within an execution environment 302 of the service node device 300. The exemplary execution environment 302 includes a processor memory for storing instructions and data included in the service node 300, a processor for accessing instructions and data in the processor memory for processing, a network subsystem for communication over a network; and can include accessible persistent storage for storing data and instructions when not needed for processing, and an operating system for managing various hardware and software components required for hosting the components in the service node device 300. Exemplary service node devices 300 can include desktop computers, servers, notebook computers, PDAs, mobile phones, and digital image capture devices.

The pub/sub service 200 hosted by the service node device 300 can include a data store 230 for storing tuples 220. In one embodiment, when the tuples can be presence tuples including a status element corresponding to a principal's status, the pub/sub service 200 can be a presence service. The pub/sub service 200 can be configured to receive and send information from and to client nodes 700a, 700b via a network 310 using a pub/sub communications protocol, such as a presence protocol. The network 310 may be a Local Area Network (LAN) and/or a Wide Area Network (WAN) including the Internet.

With reference to FIG. 1, in block 100 a message is received that identifies a principal and includes subscription information identifying a schema that specifies a set of constraints that defines a structure and vocabulary of a conforming tuple. According to an exemplary embodiment, a system for providing a subscription to a tuple based on a schema associated with the tuple includes means for receiving the message that identifies the principal and includes subscription information identifying a schema that specifies a set of constraints that defines a structure and vocabulary of a conforming tuple. For example, FIG. 2 depicts a message router component 202 for receiving the message that identifies the principal and includes subscription information identifying a schema that specifies a set of constraints that defines a structure and vocabulary of a conforming tuple.

According to an exemplary embodiment, the identified schema can be at least a portion of a schema for any portion of a pub/sub or presence tuple 220. For example, the schema can be at least a portion of a schema specifying a tuple according to SIP SIMPLE or XMPP-IM, or a pub/sub tuple as defined by XEP-0060 published by the Jabber Foundation, or at least a portion of any schema specifying a presence tuple or a tuple without a status element and/or contact information such as in a communication address element that otherwise conforms to RFCs 2778 and 2779, RFC 3921 to Saint-Andre, titled “Extensible Messaging and Presence Protocol (XMPP): Instant Messaging and Presence” (October 2004), RFC 3859 to Peterson et al., titled “Common Profile for Presence (CPP)” (August 2004) or RFC 3863 to Sugano et al., titled “Presence Information Data Format” (August 2004), or any of their variants or extensions.

The identified schema can be used to determine whether a tuple is valid according to the schema. For example, a schema specifying an XML type tuple can be processed by an XML parser, such as a document object model (DOM) parser and/or a simple API for XML (SAX) parser, to determine whether at least a portion of a tuple conforms to the constraints established by the schema. A tuple, or portion thereof, that meets the schema constraints is said to be a conforming tuple with respect to the schema. A conforming tuple can also be referred to as a valid tuple with respect to the schema.

The received message can identify a principal represented by a client node configured for sending the message and/or can identify a principal represented by another client node as described below.

According to one embodiment, the message can be a subscribe message received from a pub/sub client (not shown) hosted by the client node 700a via the network 310. For example, the message can include a subscription request where the subscription information identifies a subscribing principal and thus a watcher in the client node 700a sending the message. The subscription information can be extended to allow a schema to be included and/or referenced in the subscription information.

According to another embodiment, the message can be a publish message received from the pub/sub client (not shown) hosted by the client node 700a sending the message via the network 310. For example, an identified tuple 220 can be supported by the pub/sub service 200 for receiving the subscription information identifying the schema. The identified principal can be the publisher, represented by a sending client, of the tuple information including the subscription information. Alternatively or additionally, the identified principal can be a principal represented by another client node. A publish message from a sending node can identify a principal, associated with subscription information, other than the principal represented by the sending node. For example, the message router 202 in the service node 300 can receive a publish message via the network 310 from a presentity (not shown) operating in a sending client node 700b representing a principal different than the principal identified in the message represented by another client node, such as the principal associated with the first client node 700a.

In another alternative embodiment, the message can be a notification message identifying the principal and including the subscription information identifying the schema. For example, the message router 202 can receive a notification message from another pub-sub service 200a using a pub/sub protocol, or from an event notification service (not shown) using an event notification protocol. In one embodiment, the message router component 202 can function as a watcher component configured for receiving the notification message. The notification message can be associated with a subscription. Thus, the notification can be a solicited message or it can be an unsolicited message.

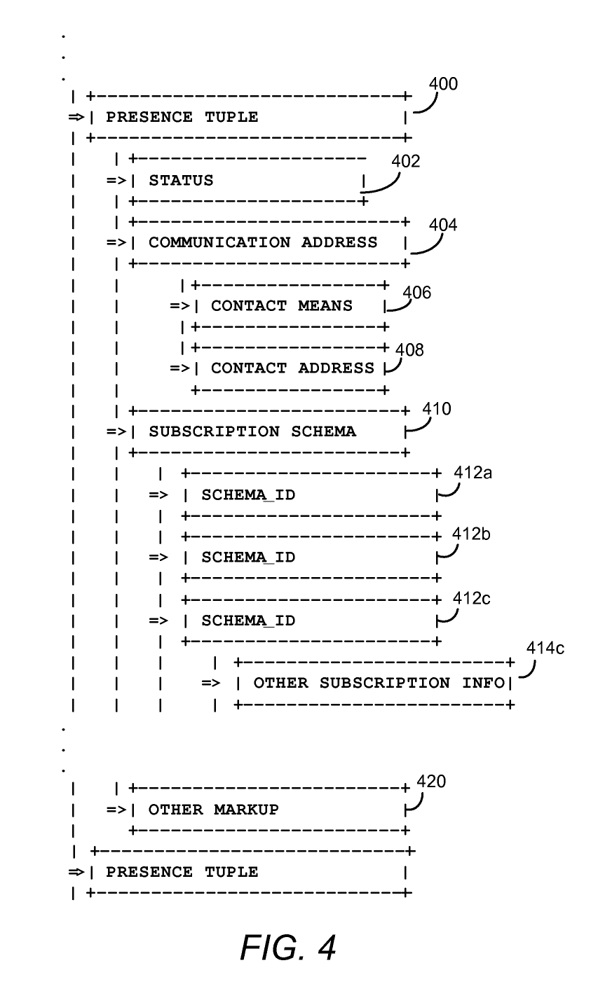

FIG. 4 is an exemplary presence tuple to published by a client representing a principal for establishing a subscription to another tuple based on schema identified in the published tuple. The tuple 400 can include a status element 402 for providing a status of the principal represented by the tuple 400. The status element 402 can be a single or multi-valued status and can include location information. An optional communication address element 404 can be included where the communication address element 404 includes zero or more pairs of contact means elements 406 and contact address elements 408. An “other markup” element 420 is depicted indicating that the format of the tuple 400 can be extended. The tuple elements described above are well-known to those skilled in the art. For example, definitions and examples of the tuple elements described above can be found in RFC 2778 and RFC 2779.

According to an exemplary embodiment, the tuple 400 also includes a subscription schema element 410 for indicating that a subscription to a tuple conforming to a schema identified by the subscription schema element is to be established. In one embodiment, the subscription schema element 410 can include at least one schema_ID element 412a, 412b, 412c for specifying subscription information that at least partially specifies the schema. For instance, the schema_ID element 412a can specify subscription information that includes a URI identifying the schema. The following example is an exemplary schema_ID element 412a expressed in XML:

```
<schema-subscriptions>
      <schema-ID>http://myserver.com/schemas/
      botany.xsd</schema-ID>
      <schema-ID>http://myserver.com/schemas/
      myOldCars.dtd</schema-ID>
      ...
</schema-subscriptions>
```

While the example above identifies a schema written in XML schema (.xsd) and one written in document type definition (DTD) language, a schema written in any of the many different schema languages can be supported.

According to another embodiment, a schema_ID element 412 can also include an “other subscription information” element for specifying information identifying a principal other than the publishing principal for which the subscription to the conforming tuple is to be established, as illustrated by the “other subscription information” element 414c included in the schema_ID tuple 412c. In another exemplary embodiment, the other subscription information element 414c can specify subscription information that also includes a search criteria. For instance, the subscription information can include information for matching a tuple element and/or a tuple element value. In this case, the tuple element can be matched by a tuple attribute.

In one embodiment, the message router component 202 receives the message that identifies a principal and includes subscription information identifying a schema from the client node 700a or from the pub/sub service 200a via a network protocol stack 304, which routes the request to a pub/sub communications protocol layer 306 supported by the pub/sub service 200. The communications protocol layer 306 then passes the message to the message router component 202 in the pub/sub service 200.

Returning to FIG. 1, after receiving the message, in block 102 a conforming tuple is determined where at least a portion of the conforming tuple conforms to the identified schema. According to an exemplary embodiment, the system for providing a subscription to a tuple based on a schema associated with the tuple includes means for determining a conforming tuple, where at least a portion of the conforming tuple conforms to the identified schema. For example, FIG. 2 includes a conformance detector component 204 configured for determining a conforming tuple, where at least a portion of the conforming tuple conforms to the identified schema.

According to an exemplary embodiment, the conformance detector component 204 can be configured to receive the subscription information identifying the schema from the message router component 202 and to retrieve the identified schema based on, for example, a URI identifying the schema. In another embodiment, the message router component 202 can also be configured to retrieve the schema identified by the subscription information and to provide the schema to the conformance detector component 204. Once the identified schema is retrieved, the conformance detector component 204 can be configured to validate at least a portion of an existing tuple and/or a newly created tuple according to the identified schema to determine that at least a portion of the tuple conforms to the identified schema.

In another exemplary embodiment, when a tuple 220 is created or otherwise updated, the tuple 220 or a portion thereof, can be validated by a publication handler component 208 and/or the tuple data store 230 interoperating with the conformance detector component 204. Each tuple can have one or more associated schemas to which at least a portion of the tuple conforms. In this case, the identified schema received in the subscription information can be used to search the tuple data store 230 for conforming tuples, i.e., tuples that include at least a portion that conforms with the schema identified in the received message. A schema identified in subscription information can be a subset of a schema previously associated with a tuple, and/or can be comprised of at least portions of one or more schemas previously associated with a tuple.

As stated above, the message identifying the principal and including the subscription information can be a subscribe message, a publish message, or a notification message. When the message is a subscribe message, the message router component 202 and the conformance detector component 204 can operate as described above. That is, the conformance detector component 204 and/or the message router component 202 can retrieve the identified schema, and the conformance detector component 204 can identify one or more tuples including at least a portion conforming to the identified schema by, for example, searching the tuple data store 230 for a conforming tuple, and/or determining whether a tuple is a conforming tuple in response to the creation of a new tuple and/or an updating of an existing tuple.

Alternatively, when the identified principal and subscription information is received in a subscription message, the message router 202 can route the message to the subscription handler 206. The subscription handler 206 can be configured to interoperate with the conformance detector component 204 for determining a conforming tuple by searching the tuple data store 230, validating tuples as they are created, and/or validating tuples as they are updated. When a tuple is validated by the conformance detector component 204 determining a conforming tuple, the subscription handler component 206, in response, can establish a subscription for the identified principal associated with the subscription information identifying the schema to which the tuple conforms.

Alternatively, when the identified principal and subscription information is received in a publish message, the message router component 202 can route the publish message to the publication handler component 208, which can be configured to update a tuple associated with the publishing principal. Furthermore, in one embodiment, the publication handler component 208 can be configured to provide the subscription information and principal identifier to the conformance detector component 204 for identifying one or more tuples including at least a portion conforming to the identified schema as described above.

Alternatively, when the identified principal and subscription information is received in a notification message, the message router component 202 can function as a watcher and the conformance detector component 204 can function as a subscriber for receiving the notification. In another embodiment, the conformance detector component 204 can be viewed as a watcher and the subscription handler component 206 can operate in the role of a subscriber for receiving the notification. Regardless of the how the roles are configured and/or perceived, the conformance detector component 204 can be configured to determine a tuple including at least a portion conforming to the identified schema according to an exemplary embodiment.

FIG. 2 and FIG. 3 depict an embodiment where a single conformance detector component 204 operates external to the message router component 202, the subscription handler component 206, and the publication handler component 208. In another embodiment, a conformance detector component can be configured to operate within one or more of the named components.

Returning to FIG. 1, once a conforming tuple is determined, in block 104 a subscription to the conforming tuple based on the subscription information is established for the principal identified by the received message. According to an exemplary embodiment, the system for providing a subscription to a tuple based on a schema associated with the tuple includes means for establishing for the identified principal a subscription to the conforming tuple based on the subscription information. For example, FIG. 2 includes a subscription handler component 206 configured for establishing for the identified principal a subscription to the conforming tuple based on the subscription information.

According to one embodiment, when the identified principal and subscription information is received, for example in a subscribe message, a publish message, or a notification message, the conformance detector component 204 can be invoked as described above to determine a conforming tuple. The conformance detector component 204 can be further configured to send a request to the subscription handler component 206 for establishing for the identified principal a subscription to the determined conforming tuple. In one embodiment, the subscription handler component 206 can be configured for adding an identifier associated with the identified principal to a subscription list associated with the conforming tuple.

When the conforming tuple is updated by the publication handler component 208, the subscription handler component 206 can be configured to interoperate with a notification handler component 210 for generating a notification including at least a portion of the conforming tuple in a notification message. The notification message can be provided to the message router component 202 by the notification handler component 210 for sending to the identified principal. For example, the message router component 202 can be configured to interoperate with the pub/sub protocol layer 306 for sending the updated tuple information to the identified principal, e.g., associated with the client node 700a, in a message formatted according to the configured pub/sub protocol via the network protocol stack 304 and the network 310 to a watcher operating in the client node 700a operatively coupled to the network 310.

Alternatively, when the received message is a publish, notification, or other event message, the publication handler component 208 can identify a proxy tuple associated with the received message and/or the identified principal for updating based on the received message. The subscription information and identified principal can be published to the proxy tuple, updating the proxy tuple. The proxy tuple can be an existing tuple or can be created in response to receiving the message. In one embodiment, the subscription handler component 206 can add an identifier associated with the identified principal to a subscription list of the proxy tuple, and can add an identifier associated with the proxy tuple to a subscription list associated with the conforming tuple, such that the proxy tuple serves as a proxy for the conforming tuple and is operatively watching the conforming tuple. In one embodiment, an update to the conforming tuple results in the subscription handler component 206 notifying a watching agent (not shown) associated with the proxy tuple. The watching agent can interoperate with the notification handler component 210 for generating a notification message including at least a portion of the conforming tuple.

Alternatively, the watching agent can be configured to operate as a presentity, with respect to the proxy tuple, publishing information in response to receiving a notification for updating at least a portion of the proxy tuple for which a subscription is established for the identified principal by the subscription handler component 206 as described above. The updating of the proxy tuple results in the subscription handler component 206 interoperating with the notification handler component 210 for generating a notification message including at least a portion of the conforming tuple to send to the identified principal having the subscription.

In one exemplary embodiment, the proxy tuple can be implemented as a policy tuple disclosed in co-pending U.S. patent application Ser. No. 11/306,341, entitled “METHODS, SYSTEMS, AND COMPUTER PROGRAM PRODUCTS FOR ASSOCIATING POLICIES WITH TUPLES USING A PUB/SUB PROTOCOL,” filed on Dec. 23, 2005, owned by the owner of the present application, and incorporated here by reference in its entirety. For example, the proxy tuple can be a policy tuple that is associated with a subscription to a conforming tuple. When the conforming tuple is updated, a policy handler can receive a notification relating to the update and can generate a message indicating an associated action, e.g., that a notification message should be sent to the identified principal. The message can then be sent to a policy enforcer for performing the associated action.

According to an exemplary embodiment, the subscription to a conforming tuple can be static or dynamic. That is, the publication handler component 208 can be configured to update the conforming tuple in such a way that the updated tuple no longer conforms to the identified schema. The subscription handler component 206 can be configured to maintain the subscription to the updated nonconforming tuple or to terminate the subscription to the updated nonconforming tuple. That is, the subscription handler 206 can be configured to maintain a subscription to a conforming tuple once it is established. The subscription can be maintained even during periods when no portion of the tuple conforms to the identified schema. Alternatively, the subscription handler 206 can be configured to validate a tuple via the conformance detector component 204 when the tuple is updated or created. If the updated/created tuple is valid with respect to the identified schema, a subscription can be established or maintained by the subscription handler component 206. If the tuple is determined by the conformance detection handler 204 to have no portion that is valid with respect to the identified schema, an established subscription can be terminated by the subscription handler component 206.

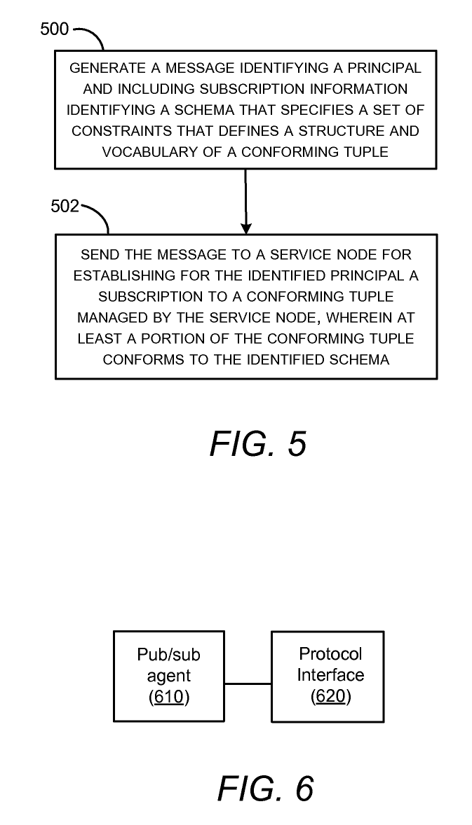

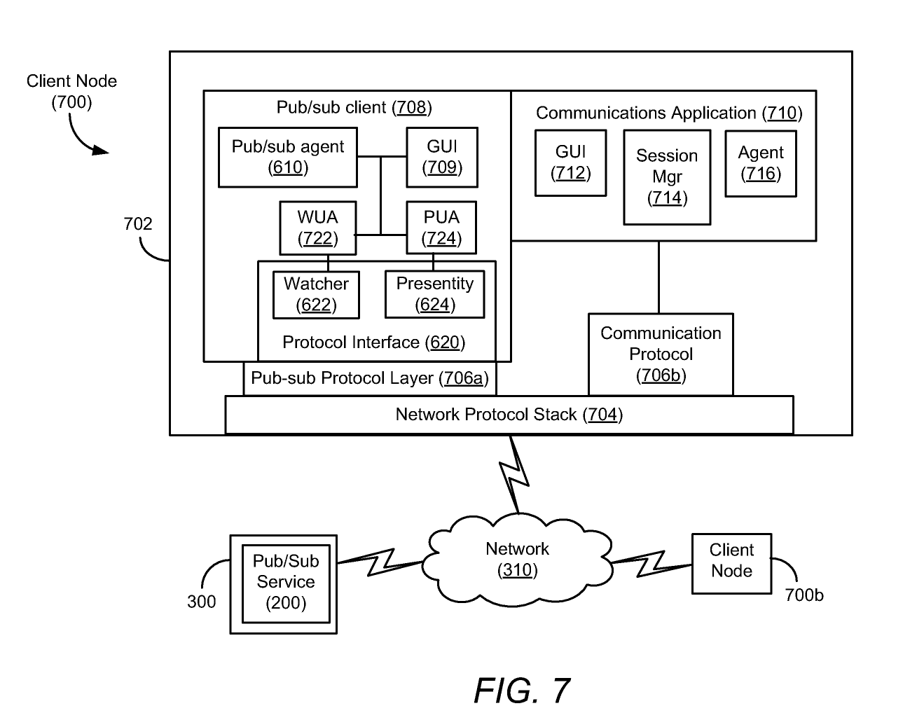

FIG. 5 is a flow diagram illustrating a method for providing a subscription to a tuple based on a schema associated with the tuple according to another aspect of the subject matter described herein. FIGS. 6 and 7 are block diagrams illustrating systems for providing a subscription to a tuple based on a schema associated with the tuple according to other embodiments. In particular, FIG. 7 illustrates a client node-based system that includes the components of FIG. 6. The method illustrated in FIG. 5 can be carried out by, for example, each of the exemplary systems illustrated in FIGS. 6 and 7.

The components illustrated in FIG. 6 are adaptable for operating within an execution environment of a device and/or or an execution environment hosted across a plurality of devices. The components illustrated in FIG. 6 can be adapted to operate within a wide range of execution environments and devices. For example, the components in FIG. 6 can operate in an execution environment including hardware, such as a processor, for processing instructions included in the components illustrated in FIG. 6, and a processor memory for storing at least a portion of the components illustrated in FIG. 6 allowing the processor to access instructions and data included in the system.

Illustrated in FIG. 7 is a client node device 700 that hosts a pub/sub client 708 that includes the components illustrated in FIG. 6 operating within an execution environment 702 of the client node device 700. Exemplary client node devices 700 can include desktop computers, servers, notebook computers, PDAs, mobile phones, and digital image capture devices. The pub/sub client 708 hosted by the client node device 700 can be configured to receive and send information from and to other client nodes 700b and the service node 300 via the network 310 using a pub/sub communications protocol, such as a presence protocol.

With reference to FIG. 5, in block 500 a message is generated that identifies a principal and includes subscription information identifying a schema that specifies a set of constraints that defines a structure and vocabulary of a conforming tuple. According to an exemplary embodiment, a system for providing a subscription to a tuple based on a schema associated with the tuple includes means for generating a message identifying a principal and including subscription information identifying a schema that specifies a set of constraints that defines a structure and vocabulary of a conforming tuple. For example, FIG. 6 illustrates a pub/sub agent 610 configured for generating a message identifying a principal and including subscription information identifying a schema that specifies a set of constraints that defines a structure and vocabulary of a conforming tuple.

According to an exemplary embodiment, the pub/sub client 708 can include a watcher user agent (WUA) 722 and a presence user agent (PUA) 724. As stated above, the generated message can be a subscribe message, a publish message, or a notification message. Accordingly, the pub/sub agent 610 can be configured in one embodiment to interoperate with the WUA 722 and/or the PUA 724 to generate a subscribe message and/or a publish message, respectively, that identifies a principal and includes subscription information identifying a schema that specifies a set of constraints that defines a structure and vocabulary of a conforming tuple. The subscribe and/or publish message can be formatted according to a pub/sub protocol, such as a presence protocol.

In another embodiment where the generated message is a notification message, the functionality of the pub/sub agent 610 can be included in a notification service, for example, of the pub/sub service 200 hosted by the service node 300. For example, the notification handler component 210 (FIG. 3) can operate as a pub/sub agent 610 in the pub/sub service 200, while in an event service (not shown), an event handler component can operate as the pub/sub agent 610 in another arrangement of components for generating a message identifying a principal and including subscription information identifying a schema. In an event service, a pub/sub agent can be configured for generating a message identifying a principal and including subscription information identifying a schema formatted according to an event notification protocol that can be a protocol that is not be a pub/sub protocol.

According to an exemplary embodiment, the subscription information to be included in the generated message can be provided as an input to the pub/sub agent 610. For example, in FIG. 7, the pub/sub client 708 can include a pub/sub GUI 709. In one embodiment, the schema can be identified by the pub/sub GUI 709 based on user input, configuration input, and/or contextual input. The pub/sub GUI 709 can be configured to present representations of one or more tuple elements or larger tuple portions containing information that can identify principals of interest or tuple data of interest to a user, e.g., principal, of a communications application 710 coupled to the pub/sub client 708. Alternatively, the pub/sub client 708 can be integrated within the communications application 710.

The communication application 710 can include, in one embodiment, an arrangement of components for sending and receiving messages, such as instant messages (IMs). The arrangement includes a GUI 712 for presenting messages and for receiving input for generating messages to be sent; an optional Session Manager 714 for managing one or more ongoing communications sessions, and an agent 716 for generating messages and for receiving messages from other clients. Messages are sent and received via a communication protocol layer 706b, such as an IM protocol layer, interoperating with a network stack 704 interoperatively coupled to the network 310. IM is an exemplary form of communication that can be included in the communication application 710 and used along with the pub/sub client 708. Other forms of communication that can be supported include voice, e.g., VOIP, video, email, MMS, SMS, FTP, and the like. Alternatively, any of these forms of communication can be transported via a pub/sub protocol, as supported by a protocol layer 706a, thereby reducing the number of protocols that require development, support, and configuration.

The pub/sub GUI 709 can provide an interface allowing user input to indicate subscription information for establishing a subscription to a tuple based on its schema. For example, the pub/sub GUI 709 can be configured to receive a URI identifying the schema. The pub/sub GUI 709 can additionally be configured to receive tuple elements, tuple element values, search criteria and/or expressions that can be included in the subscription information along with the information identifying the schema. For example, the user may be interested in subscribing to tuples including active auction sub-tuples. Thus, in addition to identifying the schema associated with active auction tuples, the subscription information can include auction element tuple values or expressions for matching specific types of items, prices ranges, and/or seller locations. In another example, the pub/sub GUI 709 can be configured to receive input indicating a schema associated with voice contact tuples and an expression matching an area code and a last name. The pub/sub GUI 709 can provide the subscription information to the pub/sub agent 610 for generating the message.

In one embodiment, the principal identified in the message can be identified based on configuration information received via user input, a data storage component, and/or a message received via the network 310. For example, the configuration information can be received automatically, similar to how IP addresses are provided automatically by DHCP or other directory services, and/or can be received via a broadcast or otherwise unsolicited message from one or more clients.

In one embodiment, the identified principal can be a user or a component of a client node sending the message. Additionally and/or alternatively, the identified principal can be represented by and/or included in another client device. The identified principal can also be associated with a group and/or a user or component associated with an entity generating the message. When the identified principal is associated with a group, the pub/sub agent 610 can generate a publish message including the subscription information from a member of the group associated with the identified principal.

Returning to FIG. 5, once the message is generated, in block 502 the message is sent to a service node for establishing for the identified principal a subscription to a conforming tuple managed by the service node, where at least a portion of the conforming tuple conforms to the identified schema. According to an exemplary embodiment, a system for providing a subscription to a tuple based on a schema associated with the tuple includes means for sending the message to a service node for establishing for the identified principal a subscription to a conforming tuple managed by the service node, wherein at least a portion of the conforming tuple conforms to the identified schema. For example, FIG. 6 illustrates a protocol interface component 620 configured for sending the message to a service node for establishing for the identified principal a subscription to a conforming tuple managed by the service node, wherein at least a portion of the conforming tuple conforms to the identified schema.

According to one embodiment, the protocol interface component 620 can be a pub/sub protocol interface, such as a presence protocol interface. For example, as shown in FIG. 7, the protocol interface component 620 can include a watcher 622 and a presentity 624. The protocol interface component 620 can send the message as a subscribe message received from the WUA 722 via the watcher 622, or can send the message as a publish message received from the PUA 724 via the presentity 624.

Alternatively, the message can be sent as a notification message or an event message as described above. When the message is sent as a notification message by the pub/sub service 300, the notification handler component 210 can be configured for sending the notification message. The event handler component (not shown) described above can be analogously configured for sending the message as an event and/or notification of the type supported by an event service (not shown) operating in a supporting execution environment.

The protocol interface component 620 can send the message via the network 310 to the service node 300. The message can be sent via a pub-sub protocol layer 706a, such as a presence protocol layer. The protocol layer 706a can interoperate with the network stack 704 for providing the message to the network 310 for transmitting to the service node 300.

According to an exemplary embodiment, when the pub/sub service 200 hosted by the service node 300 receives the message, a subscription to a conforming tuple managed by the service node 300 is established for the principal identified by the message. The subscription can be established according to the embodiments described above with respect to FIGS. 1, 2 and 3.

In response to sending the message, a notification message including a current value of an element of the conforming tuple can be received by the WUA 722. The notification message is associated with the subscription to the conforming tuple established for the identified principal. The notification message can be received from the network 310 by the network protocol stack 704 of the sending client node 700, or by another client node 700b, depending on the principal identified. The notification message is routed to the protocol layer 706a for delivery to the watcher 622 in the protocol interface component 620 as depicted in FIG. 7. The watcher 622 determines the WUA 722 associated with the subscription. The WUA 722 receives the notification message on behalf of a watching principal from the watcher 622 and processes the message for the principal.

In one embodiment, the WUA 722 can be configured to provide tuple information received in the notification message to the GUI 709 for presenting to the principal represented by the pub/sub client 708. The notification message can be received based on a subscription to the conforming tuple. Additionally or alternatively, the notification message can be received indirectly based on a subscription to a tuple serving as a proxy. A subscription via proxy tuple can, for example, be established by sending a publish message by, for example, the presentity 624. The message identifies a principal and includes subscription information identifying a schema for updating the receiving proxy tuple. A subscription can be established for a corresponding watcher of the publishing presentity, such as the watcher 622 corresponding to the presentity 624, The subscription is to the receiving proxy tuple for receiving notifications in response to updates to the tuple conforming to the identified schema. Thus, the subscription is a subscription to the conforming tuple via the receiving proxy tuple.

For example, when the subscription information identifies a schema associated with tuples having live auction items, the watcher 622 can receive notifications from tuples including at least a portion that conform to the identified auction schema. This allows the user/principal of the device including the watcher 622 to identify principals with items for auction, thereby enabling communication with one or more of the principals participating in one or more of the auctions.

It should be understood that the various components illustrated in the various block diagrams represent logical components that are configured to perform the functionality described herein and may be implemented in software, hardware, or a combination of the two. Moreover, some or all of these logical components may be combined, some may be omitted altogether, and additional components can be added while still achieving the functionality described herein. Thus, the subject matter described herein can be embodied in many different variations, and all such variations are contemplated to be within the scope of what is claimed.

To facilitate an understanding of the subject matter described above, many aspects are described in terms of sequences of actions that can be performed by elements of a computer system. For example, it will be recognized that the various actions can be performed by specialized circuits or circuitry (e.g., discrete logic gates interconnected to perform a specialized function), by program instructions being executed by one or more processors, or by a combination of both.

Moreover, the methods described herein can be embodied in executable instructions stored in a computer readable medium for use by or in connection with an instruction execution machine, system, apparatus, or device, such as a computer-based or processor-containing machine, system, apparatus, or device. As used here, a “computer readable medium” can include one or more of any suitable media for storing the executable instructions of a computer program in one or more of an electronic, magnetic, optical, electromagnetic, and infrared form, such that the instruction execution machine, system, apparatus, or device can read (or fetch) the instructions from the computer readable medium and execute the instructions for carrying out the described methods. A non-exhaustive list of conventional exemplary computer readable medium includes: a portable computer diskette; a random access memory (RAM); a read only memory (ROM); an erasable programmable read only memory (EPROM or Flash memory); optical storage devices, including a portable compact disc (CD), a portable digital video disc (DVD), a high definition DVD (HD-DVD™), a Blu-ray™ disc; and the like.

Thus, the subject matter described herein can be embodied in many different forms, and all such forms are contemplated to be within the scope of what is claimed. It will be understood that various details of the invention may be changed without departing from the scope of the claimed subject matter. Furthermore, the foregoing description is for the purpose of illustration only, and not for the purpose of limitation, as the scope of protection sought is defined by the claims as set forth hereinafter together with any equivalents thereof entitled to.

What is claimed is:

1. A system for providing a subscription to a tuple based on a schema associated with the tuple, the system comprising:
a message router component configured for receiving a message identifying a principal and including subscription information identifying a schema that specifies a set of constraints that defines a structure and vocabulary of a conforming tuple;
a conformance detector component configured for determining a conforming tuple, wherein at least a portion of the conforming tuple conforms to the identified schema; and
a subscription handler component configured for establishing for the identified principal a subscription to the conforming tuple based on the subscription information.

2. The system of claim 1 wherein the message is formatted according to at least one of a publish-subscribe protocol and an event notification protocol, and wherein the message is at least one of a subscribe message, a publish message and a notification message.

3. The system of claim 2 wherein the publish-subscribe protocol is a presence protocol.

4. The system of claim 1 wherein the identified principal is represented by at least one of a client node sending the message and a principal represented by another client node.

5. The system of claim 1 wherein the schema is at least partially specified in the subscription information.

6. The system of claim 1 wherein the subscription information further includes a search criteria.

7. The system of claim 1 wherein the conformance detector component is further configured for validating at least a portion of at least one of an updated tuple and a newly created tuple according to the identified schema to determine that at least a portion of the tuple conforms to the identified schema.

8. The system of claim 1 wherein the subscription handler component is further configured for at least one of adding an identifier associated with the identified principal to a subscription list associated with the conforming tuple; and adding an identifier associated with the identified principal to a subscription list of a proxy tuple associated with at least one of the received message and the identified principal, and adding an identifier associated with the proxy tuple to a subscription list of the conforming tuple.

9. The system of claim 1 further including a notification handler component configured for generating a notification including at least a portion of the conforming tuple in a notification message, wherein the notification message is associated with a subscription in a subscription list of at least one of the conforming tuple and a proxy tuple associated with at least one of the received message and the identified principal.

10. The system of claim 1 further including a notification handler component configured for sending a notification message to the identified principal when the conforming tuple is updated, the notification message including at least a portion of the conforming tuple.

11. The system of claim 1 further including a publication handler component for updating the conforming tuple so that the updated tuple no longer conforms to the identified schema, and wherein the subscription handler component is further configured for maintaining the subscription to the updated nonconforming tuple.

12. The system of claim 1 further including a publication handler component for updating the conforming tuple so that the updated tuple no longer conforms to the identified schema, and wherein the subscription handler component is further configured for terminating the subscription to the updated nonconforming tuple.

13. A system for providing a subscription to a tuple based on a schema associated with the tuple, the system comprising:
a publish-subscribe agent configured for generating a message identifying a principal and including subscription information identifying a schema that specifies a set of constraints that defines a structure and vocabulary of a conforming tuple; and
a protocol interface component configured for sending the message to a service node for establishing for the identified principal a subscription to a conforming tuple managed by the service node, wherein at least a portion of the conforming tuple conforms to the identified schema.

14. The system of claim 13 further including a watcher user agent component configured for receiving a notification message in response to sending the message, the notification message including a current value of an element of the conforming tuple.

15. The system of claim 13 wherein the identified principal is represented by at least one of a client node sending the message and a principal represented by another client node.

16. The system of claim 13 wherein the message is formatted according to at least one of a publish-subscribe protocol and an event notification protocol, and wherein the message is at least one of a subscribe message, a publish message and a notification message.

17. The system of claim 13 wherein the schema is at least partially specified in the subscription information.

18. The system of claim 13 wherein the subscription information further includes a search criteria.

19. A method for providing a subscription to a tuple based on a schema associated with the tuple, the method comprising:
generating a message identifying a principal and including subscription information identifying a schema that specifies a set of constraints that defines a structure and vocabulary of a conforming tuple; and
sending the message to a service node for establishing for the identified principal a subscription to a conforming tuple managed by the service node, wherein at least a portion of the conforming tuple conforms to the identified schema.

20. The method of claim 19 further including receiving a notification message in response to sending the message, the notification message including a current value of an element of the conforming tuple.

21. The method of claim 19 wherein the identified principal is represented by at least one of a client node sending the message and a principal represented by another client node.

22. The method of claim 19 wherein the message is formatted according to at least one of a publish-subscribe protocol and an event notification protocol, and wherein the message is at least one of a subscribe message, a publish message and a notification message.

23. The method of claim 19 wherein the subscription information further includes a search criteria.

24. A method for providing a subscription to a tuple based on a schema associated with the tuple, the method comprising:
receiving a message identifying a principal and including subscription information identifying a schema that specifies a set of constraints that defines a structure and vocabulary of a conforming tuple;
determining a conforming tuple, wherein at least a portion of the conforming tuple conforms to the identified schema; and
establishing for the identified principal a subscription to the conforming tuple based on the subscription information.

25. The method of claim 24 wherein the message is formatted according to at least one of a publish-subscribe protocol and an event notification protocol, and wherein the message is at least one of a subscribe message, a publish message and a notification message.

26. The method of claim 24 wherein the publish-subscribe protocol is a presence protocol.

27. The method of claim 24 wherein the identified principal is represented by at least one of a client node sending the message and a principal represented by another client node.

28. The method of claim 24 wherein the schema is at least partially specified in the subscription information.

29. The method of claim 24 wherein the subscription information further includes a search criteria.

30. The method of claim 24 wherein determining the conforming tuple includes searching a tuple data store.

31. The method of claim 24 further comprising:
receiving a message for one of creating a new tuple and updating an existing tuple; and
validating at least a portion of the updated tuple or the new tuple according to the identified schema to determine that at least a portion of the updated tuple or the new tuple conforms to the identified schema.

32. The method of claim 24 wherein establishing the subscription includes at least one of:
adding an identifier associated with the identified principal to a subscription list associated with the conforming tuple; and
adding an identifier associated with the identified principal to a subscription list of a proxy tuple associated with at least one of the received message and the identified principal, and adding an identifier associated with the proxy tuple to a subscription list of the conforming tuple.

33. The method of claim 24 further including sending a notification including at least a portion of the conforming tuple in a notification message, wherein the notification message is associated with a subscription in a subscription list of at least one of the conforming tuple and the identified principal.

34. The method of claim 24 further including sending a notification message to the identified principal when the conforming tuple is updated, the notification message including at least a portion of the conforming tuple.

35. The method of claim 24 further including updating the conforming tuple so that the updated tuple no longer conforms to the identified schema, and maintaining the subscription to the updated tuple.

36. The method of claim 24 further including updating the conforming tuple so that the updated tuple no longer conforms to the identified schema, and terminating the subscription to the updated tuple.

37. A computer readable medium containing a computer program, executable by a machine, for providing a subscription to a tuple based on a schema associated with the tuple, the computer program comprising executable instructions for:
receiving a message identifying a principal and including subscription information identifying a schema that specifies a set of constraints that defines a structure and vocabulary of a conforming tuple;
determining a conforming tuple, wherein at least a portion of the conforming tuple conforms to the identified schema; and
establishing for the identified principal a subscription to the conforming tuple based on the subscription information.

38. A computer readable medium containing a computer program, executable by a machine, for providing a subscription to a tuple based on a schema associated with the tuple, the computer program comprising executable instructions for:
generating a message identifying a principal and including subscription information identifying a schema that specifies a set of constraints that defines a structure and vocabulary of a conforming tuple; and
sending the message to a service node for establishing for the identified principal a subscription to a conforming tuple managed by the service node, wherein at least a portion of the conforming tuple conforms to the identified schema.

39. A system for providing a subscription to a tuple based on a schema associated with the tuple, the system comprising:
means for receiving a message identifying a principal and including subscription information identifying a schema that specifies a set of constraints that defines a structure and vocabulary of a conforming tuple;
means for determining a conforming tuple, wherein at least a portion of the conforming tuple conforms to the identified schema; and
means for establishing for the identified principal a subscription to the conforming tuple based on the subscription information.

40. A system for providing a subscription to a tuple based on a schema associated with the tuple, the system comprising:
means for generating a message identifying a principal and including subscription information identifying a schema that specifies a set of constraints that defines a structure and vocabulary of a conforming tuple; and
means for sending the message to a service node for establishing for the identified principal a subscription to a conforming tuple managed by the service node, wherein at least a portion of the conforming tuple conforms to the identified schema.
